(19) United States
(12) Patent Application Publication
(10) Pub. No.: US 2025/0148027 A1
(43) Pub. Date: May 8, 2025

(54) METHOD AND APPARATUS, DEVICE AND STORAGE MEDIUM FOR PROCESSING BOOK INFORMATION

(71) Applicant: Douyin Vision (Beijing) Co., Ltd., Beijing (CN)

(72) Inventor: Wenchang HUANG, Beijing (CN)

(21) Appl. No.: 18/834,989

(22) PCT Filed: May 15, 2023
(86) PCT No.: PCT/CN2023/094327

§ 371 Date: Jul. 31, 2024

(30) Foreign Application Priority Data
Jun. 30, 2022 (CN) 202210772200.3

(51) Int. Cl. G06F 16/9535; G06F 9/451

(52) U.S. Cl. CPC G06F 16/9535; G06F 9/451

(57) ABSTRACT

The disclosure relates to a method and an apparatus, a device and a storage medium for processing book information. The method includes: in response to a target triggering operation, displaying a book page, wherein the book page is configured to display book attribute information of a plurality of books; displaying recommendation information of at least one target read book in the book page, wherein the read book is a book with unread book contents; the recommendation information at least includes key information of an unread chapter in the target read book. According to the embodiment of the disclosure, the exposure rate of the target read book can be improved, the user is guided to continue reading the target read book through the recommendation information, and then the reading probability of the target read book is improved.

The disclosure claims the benefit of Chinese Patent Application No. 202210772200.3, filed on Jun. 30, 2022, entitled “METHOD AND APPARATUS, DEVICE AND STORAGE MEDIUM FOR PROCESSING BOOK INFORMATION”.

### FIELD

The disclosure relates to the technical field of electronic books, in particular to a method and an apparatus, a device and a storage medium for processing book information.

### BACKGROUND

In the book reading application, the user reads the book, if the user adds the book to the bookshelf, the book is presented in the bookshelf page; if the user does not add the book to the bookshelf, the book is presented in the historical browsing record (for example, the historical book page) of the user.

For read books in a historical book page that has not been read, often the number of books in the historical book page is too large, the interval for which the book is not read is long, and the like, so that the read books are buried and then forgotten by the user and abandoned, and the probability that the books are read is low.

### SUMMARY

In order to solve the above-mentioned technical problems, the disclosure provides a method and an apparatus, a device and a storage medium for processing book information.

According to a first aspect, the disclosure provides a method of processing book information, including:
in response to a target trigger operation, displaying a book page, wherein the book page is configured to display book attribute information of a plurality of books; and
displaying recommendation information of at least one target read book in the book page, wherein a read book is a book with unread book contents, and the recommendation information at least comprises key information of an unread chapter in the target read book.

According to a second aspect, the disclosure provides an apparatus for book information processing, including:
a book page display module, configured to display a book page in response to a target trigger operation, wherein the book page is configured to display book attribute information of a plurality of books; and
a recommendation information display module, configured to display recommendation information of at least one target read book in the book page, wherein a read book is a book with unread book contents, and the recommendation information at least comprises key information of an unread chapter in the target read book.

According to a third aspect, the disclosure provides an electronic device, including:
a processor;
a memory, configured to store an executable instruction;
wherein the processor is configured to read the executable instruction from the memory, and perform the executable instruction to implement the method of processing book information described in any embodiment of the disclosure.

According to a fourth aspect, the disclosure provides computer-readable storage medium, wherein the storage medium stores a computer program, and the computer program, when is executed by a processor, causes the processor to implement the method of book information processing of any described in any embodiment of the disclosure.

According to the method and apparatus, the device and the storage medium for book information processing provided by the embodiments of the disclosure, the book page can be displayed in response to a target triggering operation, recommendation information of at least one target read book is displayed in the book page, the read book is a book with unread book contents, and the recommendation information at least comprises key information of the unread chapter in the target read book; at least one target read book in the historically read book is recommended to the user, the exposure rate of the target read book is improved, the user is guided to continue reading the target read book through the recommendation information, and then the reading probability of the target read book is improved.

### BRIEF DESCRIPTION OF DRAWINGS

The above and other features, advantages, and aspects of various embodiments of the disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method of processing book information according to an embodiment of the disclosure;

FIG. 2 is a schematic displaying diagram of displaying recommendation information of a target read book in a bookshelf page according to an embodiment of the disclosure;

FIG. 3 is a schematic displaying diagram of displaying book attribute information in a historical book page according to an embodiment of the disclosure;

FIG. 4 is another schematic displaying diagram of displaying recommendation information of a target read book in a bookshelf page according to an embodiment of the disclosure;

FIG. 5 is a schematic displaying diagram of displaying an overview information viewing control in a reading page according to an embodiment of the disclosure;

FIG. 6 is a schematic structural diagram of an apparatus for book information processing according to an embodiment of the disclosure;

FIG. 7 is a schematic structural diagram of an electronic device according to an embodiment of the disclosure.

### DETAILED DESCRIPTION

Embodiments of the disclosure will be described in more detail below with reference to the accompanying drawings. While certain embodiments of the disclosure are shown in the drawings, it is to be understood that the disclosure may be implemented in various forms, and should not be construed as limited to the embodiments set forth herein, rather, these embodiments are provided for a more thorough and complete understanding of the disclosure. It should be understood that the drawings and embodiments of the disclosure are for exemplary purposes only and are not intended to limit the scope of the disclosure.

It should be understood that the steps recited in the method embodiments of the disclosure may be performed in different orders, and/or in parallel. Further, the method embodiments may include additional steps and/or omit performing the illustrated steps. The scope of the disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in the disclosure is illustrative and not limiting, and those skilled in the art should understand that “one or more” should be understood unless the context clearly indicates otherwise.

The names of messages or information interaction between multiple devices in embodiments of the disclosure are for illustrative purposes only and are not intended to limit the scope of such messages or information.

In the current book reading application, on one hand, a read book that is not added to a bookshelf by a user but is read but not completely read may be added to a historical browsing record (e.g., a historical book page showing read books). However, the number of books in the historical browsing record is relatively large, and the read books of interest to the user are likely to be buried, causing the user to forget and dismiss the read books, resulting in a low probability that these read books are read. On the other hand, the book reading application may recommend some books to the user to guide the user to read and reduce the cost of searching for books by the user. However, based on the consideration that the read book is read by the user and may more likely not be repeatedly read, the book recommended by the application is mainly an unread book, and also causes the read book to be buried and abandoned, and also causes a problem that the probability that the read book is read is low.

Based on the above, the embodiments of the disclosure provide a method of processing book information, to display recommendation information of at least one target read book to a user in a book page, implement recommendation and reading guidance of the read book, improve a possibility that the user continuously reads the target read book, and improve the exposure rate and the reading probability of the target read book.

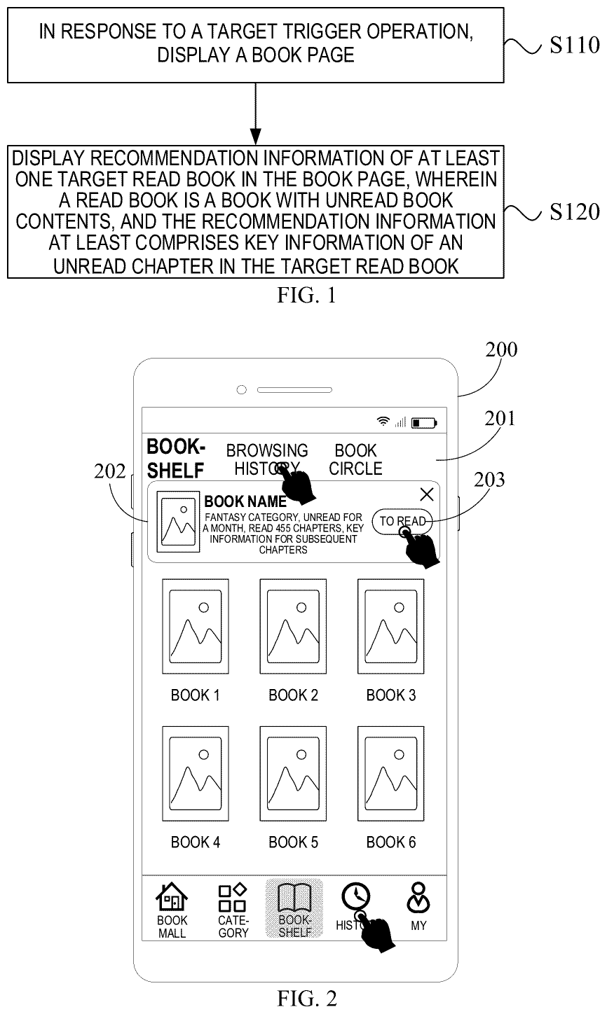

The method of processing book information provided in the embodiments of the disclosure will be described firstly below with reference to FIG. 1-5.

The method of processing book information provided by the embodiment of the disclosure can be applied to an electronic book reading scene in which a read book is converted from a shallow reading state with a small reading progress to a deep reading state with a large reading progress. The method may be performed by an apparatus for book information processing, and the apparatus may be implemented by software and/or hardware, and the apparatus may be integrated in an electronic device equipped with a book reading application, and the electronic device may include, but is not limited to, a mobile terminal such as a smart phone, a personal digital assistant (PDA), a tablet personal computer (Tablet PC), a portable multimedia player (PMP), a notebook computer, a wearable device, and the like, and a fixed terminal such as a digital television, a desktop computer, or the like.

FIG. 1 is a schematic flowchart of a method of processing book information according to an embodiment of the disclosure. As shown in FIG. 1, the method of processing book information may include the following steps.
S110: display a book page in response to a target triggering operation.

The target trigger operation is a trigger operation for triggering display of the book page, which matches the book page, that is, different book pages may correspond to different target trigger operations. The trigger operation may be, for example, a touch operation such as a click, a touch, or the like, or may be a non-contact operation such as voice control or eye movement control. The book page is configured to display book attribute information of a plurality of books. For example, the book page may be a bookshelf page, a book mall page, a historical book page showing a plurality of historically read books, and the like in the book reading application. The book attribute information herein refers to related attribute information that describes a book from various dimensions, for example, may be book identification information (for example, a book name, a book cover picture, a book brief animation or a video) used to identify a book, or may be a book popularity (for example, a score, a number of reads, a ranking, etc.), a book comment, and the like that are used to represent a popularity degree of a book, or may be a book completion status (for example, serializing, completed, and the like) used to represent a composition status of a book, or may be a book reading status (for example, read and unread, unread, read, etc.) used to represent a reading status of a book.

Specifically, the electronic device detects an interaction operation of the user. If it is detected that the interactive operation belongs to the target trigger operation, the electronic device, in response to the target trigger operation, displays the pages of the book adapted thereto, and displays the book attribute information of the adapted electronic book in the book page.

In an example, when the book page is a book mall page, the user may start an application program, or trigger a control corresponding to a “book mall” function set in a bottom area of the application program, and after detecting the trigger operation, the electronic device displays a book mall page, and displays at least book attribute information of the automatically recommended electronic book in the book mall page.

In another example, when the book page is a bookshelf page, the user may perform a bookshelf access operation, for example, trigger a control corresponding to a “bookshelf” function set in a bottom area of the application program, or trigger a bookshelf portal control set and displayed in a certain page of the application program, and the like. After detecting the bookshelf access operation, the electronic device displays the bookshelf page, displays the book attribute information of the electronic book added to the bookshelf by the user in the bookshelf page, and/or displays the book attribute information of the automatically recommended electronic book in the bookshelf page.

As shown in FIG. 2, in response to the bookshelf access operation, the electronic device 200 displays the bookshelf page 201, and displays a plurality of books and book attribute information thereof in the bookshelf page 201, as shown in FIG. 2.

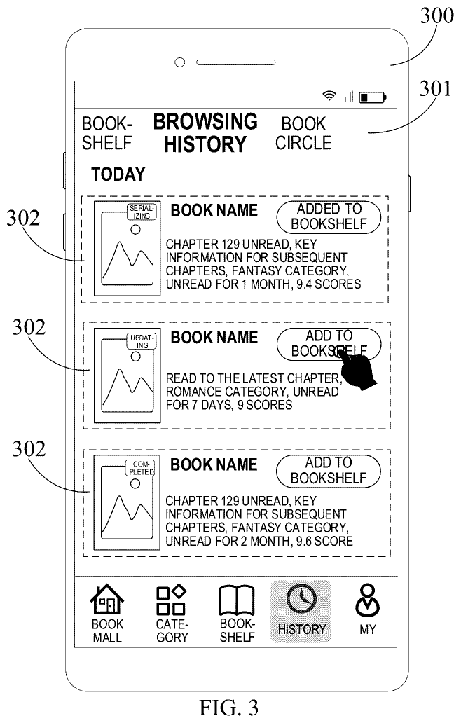

In yet another example, when the book page is a historical book page, the user may perform a historical book access operation. For example, the user triggers the control corresponding to the “history” function set in a bottom area of the application shown in FIG. 2, or the user triggers the label control corresponding to the “browsing history” function set in a top area of the application shown in FIG. 2. After detecting the historical book access operation, the electronic device displays a historical book page in response to the historical book access operation, and displays book attribute information of respective historically read books in the historical book page. The historically read book herein refers to a book read but not fully read in a time period before the current moment. As shown in FIG. 3, the electronic device 300 displays a historical book page 301 and displays the book attribute information 302 of the plurality of historically read books in the historical book page 301.

In this example, because the number of historically read books displayed in the historical book page is relatively large, and the user does not facilitate book screening, the electronic device may display more book attribute information for respective historically read books to display more book related information to the user, thereby improving the efficiency of the user performing book screening in the historical book page. That is, the book attribute information of respective historically read books in the historical book page includes book identification information and additional information, and the additional information includes at least one of reading progress, unread duration, book category, book completion status, book update status, book popularity, and key information corresponding to the unread section.

The above reading progress is information of the completion degree of reading the book by the user, for example, it may be a percentage of the read content to the entire book content, or may be a number of read chapters, or may be a number of read chapters and a page in the current reading section. The unread duration is a time interval between a moment at which the user recently reads the book and a current system time. The book update state is a state in which whether the current book content of the serializing book is added with new book content relative to the book chapter when the user reads the book last time, for example, it may be an updated state and an un-updated state. The key information corresponding to the unread chapter refers to the key information corresponding to the at least one unread chapter in the book. For example, the key information corresponding to the unread chapter may be at least one book content of important book content included in the unread chapter, hot chapter content, associated book content related to the episode included in the current reading content, and the like; for another example, the key information corresponding to the unread chapter may be at least one comment content of the all comment content corresponding to the unread chapter, the hot comment content, the associated comment content related to the episode included in the current reading content, and the like.

In addition, in order to further improve the efficiency of finding and reading the historically read book by the user, the electronic device may set a “add to bookshelf” control for respective historically read books in the historical book page 301, so that the user adds the historically read book of interest to the bookshelf through the trigger operation for the control of the “add to bookshelf”.
S120: display recommendation information of at least one target read book in the book page, wherein a read book is a book with unread book contents, and the recommendation information at least comprises key information of an unread chapter in the target read book.

The target read book is a book screened from a plurality of historically read books.

Specifically, in order to guide the user to continue reading the historically read book, the electronic device may screen at least one target read book from the plurality of historically read books. Then, the electronic device displays the target read book and the recommendation information thereof in the book page. In this way, the electronic device may display the key information corresponding to the book content that is unread by the user in the target read book to the user, to prompt the user of the key information involved in the subsequent chapter of the target read book, thereby guiding the user to discover and continue reading the buried target read book to a certain extent.

In some embodiments, before S120, the electronic device may determine the target read book and generate recommendation information thereof in the following manner: obtaining historically read books, and sorting the historically read books based on a preset sorting dimension; screening the sorted historically read books based on a preset number to determine the target read book, and generating the recommendation information corresponding to the target read book based on information of the unread chapter in the target read book.

The preset sorting dimension is a preset dimension of a book attribute used for sorting books. In this embodiment, the preset sorting dimension comprises at least one of a reading progress, an unread duration and a book category matching degree. The book category matching degree is used to represent a matching degree between a book category to which the historically read books belong and a category of interest. The preset number is a preset number value, which is used to control the number of the target read books. In this embodiment, the preset number is an integer greater than or equal to 1.

Specifically, the electronic device first obtains a plurality of historically read books corresponding to the user and within a certain time period (set according to business requirements, such as three months from the current system time). Then, for each historically read book, a score of the historically read book in each preset sorting dimension is obtained, and the scores are integrated (for example, weighted) to obtain a sorted total score of the historically read book. Then, the electronic device sorts the historically read books according to the sorted total score of each historically read book to obtain sorted historically read books. Then, the electronic device cuts, in sequence, a preset number of historically read books ranked first from the sorted historically read books as the screened target read books. Finally, for each target read book, the electronic device obtains the unread chapter information of the target read book (such as the book content of the unread chapter, the corresponding comment content, etc.) according to the reading progress of the target read book, and performs content extraction and sorting on the unread chapter information to generate recommendation information of the target read book. In this way, the target read book that more conforms to the reading interest of the user can be obtained through the setting of the preset sorting dimension, thereby further improving the reading probability of the target read book.

Further, consider that the more parts read by user, the more the user is interested in the book to some extent. Therefore, in order to improve the fitting degree between the screened target read book and user reading interest, thereby further improving the reading probability of the target read book, the electronic device may set the reading progress to the preset sorting dimension with the highest priority in the process of sorting the historically read books according to the plurality of preset sorting dimensions. For example, the higher the number of read chapters in the reading progress, the higher the sorted total score of the books.

According to the method of processing book information provided by the embodiment of the disclosure, the book page can be displayed in response to the target triggering operation, the recommendation information of the at least one target read book is displayed in the book page, the read book is the book with unread book contents, and the recommendation information at least comprises key information of the unread chapter in the target read book; at least one target read book in the historically read book is recommended to the user, the exposure rate of the target read book is improved, the user is guided to continue reading the target read book through the recommendation information, and the reading probability of the target read book is further improved.

In some embodiments, the electronic device may display the recommendation information of one target read book at a time. In this way, the S120 may be implemented as: display a banner control in a peripheral region of the book page, and display the recommendation information of one target read book in the banner control.

Specifically, each time the recommendation information of one target read book is shown, the electronic device may set a banner control in a peripheral region of the book page, that is, an edge region (for example, an upper region, a lower region, a left region or a right region of the main display region) in any direction of the main display region corresponding to respective book attribute information, and then display the recommendation information of one target read book in the control region of the banner control.

As shown in FIG. 2, the electronic device 200 displays a banner control 202 in a region above the main display region of the bookshelf page 201, and displays recommendation information of one target read book in the banner control 202.

For a clearer guiding user to read, an entry control of the reading page may be displayed in the banner control 202, that is, the entry control 203 of the reading page whose content is “to read” is displayed in FIG. 2, so that the user triggers to display the reading page of the target reading book by a trigger operation for entry control 203 of the reading page.

In an example, when the number of the target read book is one, the electronic device may display the recommendation information of the target read book in the banner control.

Specifically, according to the above description, if the number of the target read book is one, it is the top one of the sorted historically read books. In this case, the electronic device only needs to directly display the recommendation information of the target read book in the banner control.

In another example, when the number of the target read books is multiple, the electronic device may display the recommendation information of respective target read books one by one in the banner control.

Specifically, according to the above description, if the number of the target read books is multiple, they are the top ones of the sorted historically read books. In this case, in order to display target read books in the banner control with limited display region, the electronic device may repeat the target read books, that is, cycle display according to the sorting of target read books, and display the recommendation information of one target read book in the banner control each time.

In some embodiments, the electronic device may display the recommendation information of the plurality of target read books each time. In this way, the S120 may be implemented as: in response to that a number of the target read books is multiple, display a book entry control in the book page, and display prompt information for viewing the recommendation information in the book entry control; and in response to a trigger operation for the book entry control, display the recommendation information of the respective target read books at a first preset position of the book page.

The book entry control is a prompt control for viewing all the target read books, and does not directly display the recommendation information, but the prompt may display the recommendation information by triggering the prompt control. For example, the book entry control may be a banner control, a pop-up control, a floating layer control, or the like. The first preset position is a preset display region corresponding to the book page.

Specifically, when the number of target read books is multiple, in order to not affect the display of the original respective book attribute information in the book page, the electronic device may display a book entry control at a location of the book page, and display prompt information for viewing the recommendation information in the display region of the book entry control.

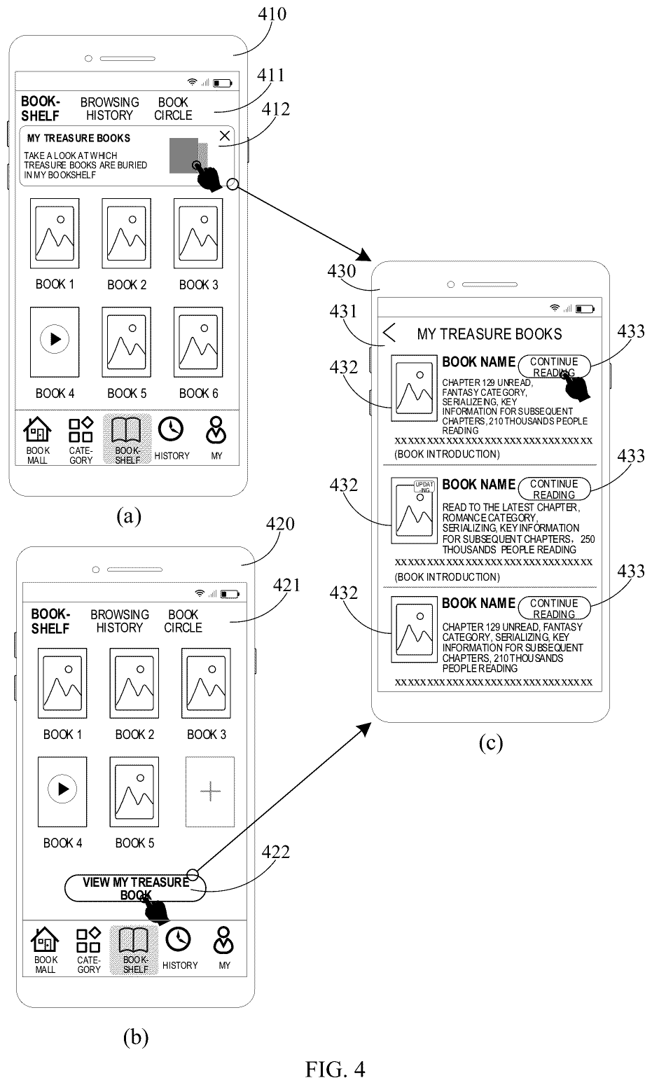

For example, referring to (a) in FIG. 4, the electronic device 410 displays a banner control in a region above the main display region of the bookshelf page 411 as the book entry control 412, and displays prompt information such as “my treasure book” and a book related identification picture in the book entry control 412, so as to prompt the user to view the buried target read books that is buried by triggering the book entry control 412.

For another example, referring to (b) in FIG. 4, the electronic device 420 may also display a book entry control 422 in a region below the main display region of the bookshelf page 421, and display prompt information of “view my treasure book” in the book entry control 412, so as to prompt the user to view the buried target read books that is buried by triggering the book entry control 422.

The user may then perform a trigger operation for the book entry control, such as clicking operation for the book entry control 412 shown in (a) in FIG. 4 or the book entry control 422 displayed in (b) in FIG. 4. After detecting the above trigger operation, the electronic device may display the recommendation information of respective target read books at the first preset position of the book page.

In an example, create a floating window in the book page, and display the respective recommendation information in the floating window.

Specifically, in this example, the first preset position is a floating window in the book page. Then, in response to the trigger operation for the book entry control, the electronic device may create and display a floating window in the book page, and display the recommendation information of respective target read books in the floating window.

In another example, move the respective book attribute information in the book page, and display the respective recommendation information in a moved blank region.

Specifically, the electronic device may move, in response to a trigger operation for the book entry control, respective book attribute information originally displayed in the book page to a certain direction (such as above, below, left side, right side, etc.) to generate a blank region in the direction in the book page. Then, recommendation information of respective target read books is displayed in the blank area.

It can be understood that, in the process of moving the book attribute information, the book attribute information exceeding the book page display range is hidden.

In still another example, the book page is switched to a new page, and the recommendation information is displayed in the new page.

Specifically, in order to display the recommendation information of respective target read books more completely and in detail, the electronic device may create a new page in response to a trigger operation for the book entry control. Then, the book page is jumped to the new page, and the recommendation information of respective target read books is displayed in the new page.

For example, after the trigger operation for the book entry control 412 shown in (a) in FIG. 4 or the book entry control 422 displayed in (b) in FIG. 4, the electronic device may jump to display a new page, as shown in (c) in FIG. 4. Referring to (c) in FIG. 4, the electronic device 430 displays a new page 431, and displays recommendation information 432 of a plurality of target read books in the new page 431.

In order to guide the user to read more clearly, an entry control of the reading page may be displayed for respective target read books in the new page, that is, the entry control 433 of the reading page whose content is “continue reading” is displayed in (c) in FIG. 4, so that the user triggers to display the reading page of the corresponding target read book by the trigger operation for the entry control 433 of the reading page.

In some other embodiments, when the electronic device may display the recommendation information of the plurality of target read books each time, the S120 may further be implemented as: in response to a number of the target read books is multiple, determine a first region and a second region in the book page, and displaying the recommendation information of the respective target read books in the first region, and displaying the respective book attribute information in the second region.

Specifically, in this embodiment, the electronic device splits the book page into at least two display region, namely, a first region and a second region. Then, the respective book attribute information and the respective recommendation information are respectively displayed in the two regions. In this way, the respective recommendation information can be directly displayed to the user, the process of triggering display of the respective recommendation information by the user through the trigger operation for the book entry control is saved, the operation cost of the user can be reduced to a certain extent, the display efficiency of the recommendation information of respective target read books under the application scenes of the multiple target read books is improved, and the exposure rate and the reading probability of respective target read books are further improved.

In some embodiments, considering that the target read book may be a read book that the user has unread for a long time, the user is likely to forget the main plots of the book. Therefore, in this embodiment, the related plots of the target read book may be prompted in the opened reading page, to assist the user to review the main content of the book, improve the coherence of reading by the user, and the reading interest of the user, thereby further improving the possibility that the user continues reading the target read book, and further improving the reading probability of the target read book.

That is, after displaying the recommendation information of the at least one target read book in the book page, the electronic device displays the reading page in response to the triggering operation for the target read book, and displays the book content corresponding to the reading progress of the triggered target read book and the overview information viewing control in the reading page; and displays the book overview information of the triggered target read book at the second preset position of the reading page in response to the triggering operation for the overview information viewing control.

The overview information viewing control is a related control configured to guide the user to view the overview information of the book, for example, may be a banner control, a floating layer control, a pop-up window control, or the like. The second preset position is a preset display position corresponding to the reading page, for example, may be a floating window, a pop-up window, a new page, or the like. The book overview information includes at least a book introduction and a book comments. The book introduction may be a book summary provided by a book author or book related platform. The book comment may be at least one of all comment content, key comment content, hot comment content corresponding to the book, related comment content of the current chapter corresponding to the reading progress, and the like.

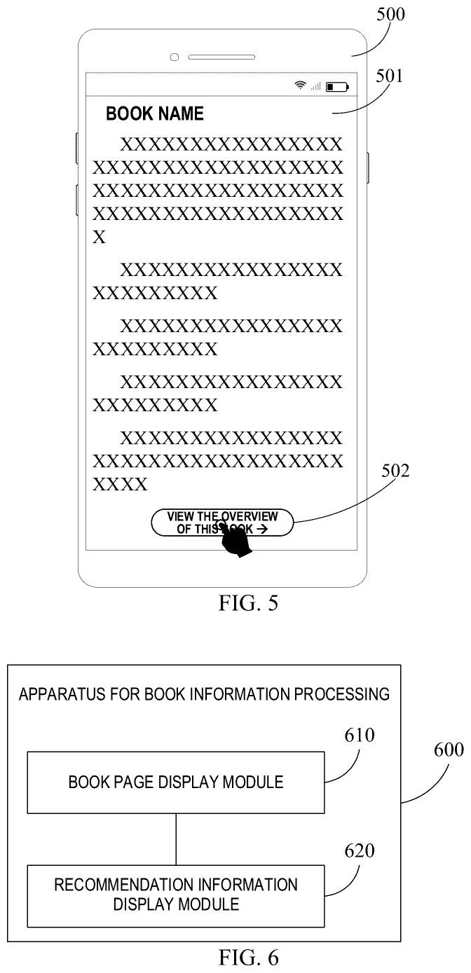

Specifically, after displaying the recommendation information of the target read book, the electronic device may detect whether there is a trigger operation for the target read book. For example, the user may perform a trigger operation for the entry control 203 of the “to read” reading page shown in FIG. 2, or perform a trigger operation for the entry control 433 of any “continue reading” reading page shown in (c) in FIG. 4. Then, the electronic device may detect the trigger operation, and in response to the trigger operation, jump to the reading page corresponding to the triggered target read book from the book page 201 shown in FIG. 2 or the new page 431 shown in (c) in FIG. 4, and display the book content corresponding to the reading progress of the target read book and the overview information viewing control in the reading page, as shown in FIG. 5.

Referring to FIG. 5, the electronic device 500 displays a reading page 501 corresponding to the triggered target read book. The reading page 501 displays the current book content in the current chapter corresponding to the reading progress of the target read book, and below the current book content, the overview information viewing control 502 is displayed with the control text “view book overview”.

Then, if the electronic device detects a trigger operation of the user for the overview information viewing control 502, the electronic device may determine a second preset position in the reading page, for example, create a pop-up window, a floating window, or a new page, and display the book overview information of the triggered target read book at the determined second preset position.

In some embodiments, after displaying the book content corresponding to the reading progress of the triggered target read book and the overview information viewing control in the reading page, the electronic device hides the overview information viewing control if the triggering operation for the overview information viewing control is not detected within the preset duration.

The preset duration is predetermined duration, which may be set according to business requirements experience.

Specifically, according to the description of the above embodiment, the electronic device displays an overview information viewing control in the reading page, which occupies a certain display space in the reading page. If the user does not need to review the main plots of the book, it is likely not to perform a trigger operation for the overview information viewing control. In this case, the display of the overview information viewing control may cause interference to the user reading the book. Therefore, the electronic device may perform timing and trigger operation detection after displaying the overview information viewing control. If the timing duration is less than or equal to the preset duration, the electronic device detects the trigger operation for the overview information viewing control, the electronic device performs the response processing according to the description of the foregoing embodiment. If the timing duration has exceeded the preset duration but still does not detect the triggering operation for the overview information viewing control, the electronic device may hide the overview information viewing control, so that the user can more conveniently read the book.

The following is an embodiment of an apparatus for book information processing according to an embodiment of the disclosure, and the apparatus is the same inventive concept as the method of processing book information in the above embodiments, and details contents not described in detail in the embodiments of the apparatus for book information processing may refer to the above embodiments of the method of processing book information.

FIG. 6 is a schematic structural diagram of an apparatus for book information processing according to an embodiment of the disclosure. As shown in FIG. 6, the apparatus 600 for processing book information may include:
the book page display module 610, configured to display a book page in response to a target trigger operation, wherein the book page is configured to display book attribute information of a plurality of books.
the recommendation information display module 620, configured to display recommendation information of at least one target read book in the book page, wherein a read book is a book with unread book contents, and the recommendation information at least comprises key information of an unread chapter in the target read book.

According to the above apparatus for book information processing provided by the embodiment of the disclosure, the book page can be displayed in response to the target triggering operation, the recommendation information of the at least one target read book is displayed in the book page, the read book is the book with unread book contents, and the recommendation information at least comprises key information of the unread chapter in the target read book; at least one target read book in the historically read book is recommended to the user, the exposure rate of the target read book is improved, the user is guided to continue reading the target read book through the recommendation information, and the reading probability of the target read book is further improved.

In some embodiments, the apparatus 600 for processing book information further includes a recommendation information generation module, configured to:
before display recommendation information of at least one target read book in the book page, obtain historically read books, and sorting the historically read books based on a preset sorting dimension, wherein the preset sorting dimension comprises at least one of a reading progress, an unread duration and a book category matching degree, and the book category matching degree is used to represent a matching degree between a book category to which the historically read books belong and a category of interest; and
screen the sorted historically read books based on a preset number to determine the target read book, and generate the recommendation information corresponding to the target read book based on information of the unread chapter in the target read book, wherein the preset number is an integer greater than or equal to 1.

In some embodiments, the recommendation information display module 620 includes a first display sub-module, configured to:
display a banner control in a peripheral region of the book page, and display the recommendation information of one target read book in the banner control.

Further, the first display sub-module is specifically configured to:
in response to a number of the target read book is one, display the recommendation information of the target read book in the banner control; and
in response to the number of the target read books is multiple, cycle display the recommendation information of the respective target read books in the banner control one by one.

In some embodiments, the recommendation information display module 620 includes a second display sub-module, configured to:
in response to that a number of the target read books is multiple, display a book entry control in the book page, and display prompt information for viewing the recommendation information in the book entry control; and
in response to a trigger operation for the book entry control, display the recommendation information of the respective target read books at a first preset position of the book page.

Further, the second display sub-module is specifically configured to:
create a floating window in the book page, and display the respective recommendation information in the floating window; or
move the respective book attribute information in the book page, and display the respective recommendation information in a moved blank region; or
switch from the book page to a new page, and display the respective recommendation information in the new page.

In some embodiments, the recommendation information display module 620 includes a third display sub-module configured to:
in response to a number of the target read books is multiple, determine a first region and a second region in the book page, and display the recommendation information of the respective target read books in the first region, and display the respective book attribute information in the second region.

In some embodiments, the apparatus 600 for processing book information further includes a book overview information display module, configured to:
after the display recommendation information of at least one target read book in the book page, in response to a trigger operation for the target read book, display a reading page, and display book contents corresponding to a reading progress of the triggered target read book and an overview information viewing control in the reading page; and
in response to a trigger operation for the overview information viewing control, display book overview information of the triggered target read book at a second preset position of the reading page, wherein the book overview information at least comprises a book introduction and a book comment.

Further, the apparatus 600 for processing book information further includes a control hiding module, configured to:
after the displaying book contents corresponding to a reading progress of the triggered target read book and an overview information viewing control in the reading page, in response to that no trigger operation for the overview information viewing control is detected within a preset duration, hide the overview information viewing control.

In some embodiments, the book page display module 610 is specifically configured to:
if the book page is a historical book page, the displaying a book page, in response to a historical book access operation, display the historical book page and display the book attribute information of the respective historically read book in the historical book page, wherein the book attribute information comprises book identification information and additional information; the additional information comprises at least one of a reading progress, an unread duration, a book category, a book completion status, a book update status, book popularity, and key information corresponding to an unread chapter.

The apparatus for book information processing provided by the embodiment of the disclosure can execute the method of processing book information provided by any embodiment of the disclosure, and has functional modules and beneficial effects corresponding to the execution method.

It should be noted that, in the foregoing embodiments of the apparatus for book information processing, the modules and sub-modules included are only divided according to the function logic, but are not limited to the above division, as long as the corresponding functions can be implemented; in addition, the specific names of the function modules/sub-modules are only for convenience of distinguishing, and are not used to limit the protection scope of the disclosure.

An embodiment of the disclosure further provides an electronic device, the electronic device may include a processor and a memory, and the memory may be configured to store an executable instruction. The processor may be configured to read the executable instruction from the memory, and execute the executable instruction to implement the method of processing book information in the foregoing embodiment.

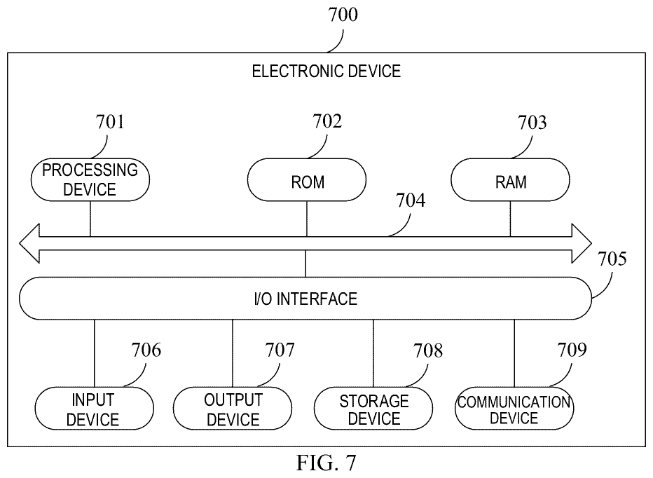

FIG. 7 is a schematic structural diagram of an electronic device according to an embodiment of the disclosure.

As shown in FIG. 7, the electronic device 700 may include a processing device (for example, a central processing unit, a graphics processor, etc.) 701, which may perform various appropriate actions and processing according to a program stored in a read-only memory (ROM) 702 or a program loaded into a random access memory (RAM) 703 from a storage device 708. In the RAM 703, various programs and data required by the operation of the information processing device 700 are also stored. The processing device 701, the ROM 702, and the RAM 703 are connected to each other through a bus 704. An input/output interface (I/O interface) 705 is also connected to the bus 704.

Generally, the following devices may be connected to the I/O interface 705: an input device 706 including, for example, a touch screen, a touchpad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data.

It should be noted that the electronic device 700 shown in FIG. 7 is merely an example, and should not bring any limitation on the functions and the use scope of the embodiments of the disclosure. That is, while FIG. 7 shows an electronic device 700 having various devices, it should be understood that it is not required to implement or have all illustrated devices. More or fewer devices may alternatively be implemented or provided.

In particular, according to an embodiment of the disclosure, the process described above with reference to the flowchart may be implemented as a computer software program. For example, embodiments of the disclosure include a computer program product comprising a computer program embodied on a non-transitory computer readable medium, the computer program comprising program code for performing the method shown in the flowchart. In such embodiments, the computer program may be downloaded and installed from the network through the communication device 709, or installed from the storage device 708, or from the ROM 702. When the computer program is executed by the processing apparatus 701, the above functions defined in the method of processing book information according to any embodiment of the disclosure are performed.

An embodiment of the disclosure further provides a computer-readable storage medium, wherein the storage medium stores a computer program, and when the computer program is executed by a processor, the processor implements the method of processing book information in any embodiment of the disclosure.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the disclosure, a computer-readable storage medium may be any tangible medium containing or storing a program that may be used by or in connection with an instruction execution system, apparatus, or device. In the disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP, and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium described above carries one or more programs, and the one or more programs described above, when are executed by the electronic device, cause the electronic device to execute the steps of the method of processing book information described in any embodiment of the disclosure.

In embodiments of the disclosure, computer program code for performing the operations of the disclosure may be written in one or more programming languages or any combination thereof, including, but not limited to, an object-oriented programming language such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of devices, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the disclosure and the principles of the application. It should be understood by those skilled in the art that the disclosure in the disclosure is not limited to the technical solutions of the specific combination of the above technical features, and should also cover other technical solutions formed by any combination of the above technical features or their equivalent features without departing from the above disclosed concept. For example, the above features can be replaced with (but not limited to) the features with similar functions disclosed in this disclosure.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1-13. (canceled)

14. A method of processing book information, comprising:
in response to a target trigger operation, displaying a book page, wherein the book page is configured to display book attribute information of a plurality of books; and
displaying recommendation information of at least one target read book in the book page, wherein a read book is a book with unread book contents, and the recommendation information at least comprises key information of an unread chapter in the at least one target read book.

15. The method of claim 14, wherein before the displaying recommendation information of at least one target read book in the book page, the method further comprises:
obtaining historically read books, and sorting the historically read books based on a preset sorting dimension, wherein the preset sorting dimension comprises at least one of a reading progress, an unread duration and a book category matching degree, and the book category matching degree is used to represent a matching degree between a book category to which the historically read books belong and a category of interest; and
screening the sorted historically read books based on a preset number to determine the target read book, and generating the recommendation information corresponding to the target read book based on information of the unread chapter in the target read book, wherein the preset number is an integer greater than or equal to 1.

16. The method of claim 14, wherein the displaying recommendation information of at least one target read book in the book page comprises:
displaying a banner control in a peripheral region of the book page, and displaying the recommendation information of one target read book in the banner control.

17. The method of claim 16, wherein the displaying the recommendation information of one target read book in the banner control comprises:
in response to that a number of the at least one target read book is one, displaying the recommendation information of the target read book in the banner control; and
in response to that the number of the at least one target read book is more than one, displaying the recommendation information of each of the at least one target read book in the banner control one by one.

18. The method of claim 14, wherein the displaying recommendation information of at least one target read book in the book page comprises:
in response to that a number of the at least one target read book is more than one, displaying a book entry control in the book page, and displaying prompt information for viewing the recommendation information in the book entry control; and
in response to a trigger operation for the book entry control, displaying the recommendation information of each of the at least one target read book at a first preset position of the book page.

19. The method of claim 18, wherein the displaying the recommendation information of the at least one target read book at a first preset position of the book page comprises:
creating a floating window in the book page, and displaying the respective recommendation information in the floating window; or
moving the respective book attribute information in the book page, and displaying the respective recommendation information in a moved blank region; or
switching from the book page to a new page, and displaying the respective recommendation information in the new page.

20. The method of claim 14, wherein the displaying recommendation information of at least one target read book in the book page comprises:
in response to a number of the target read books is more than one, determining a first region and a second region in the book page, and displaying the recommendation information of the respective target read books in the first region, and displaying the respective book attribute information in the second region.

21. The method of claim 14, wherein after the displaying recommendation information of at least one target read book in the book page, the method further comprises:
in response to a trigger operation for the target read book, displaying a reading page, and displaying book contents corresponding to a reading progress of the triggered target read book and an overview information viewing control in the reading page; and
in response to a trigger operation for the overview information viewing control, displaying book overview information of the triggered target read book at a second preset position of the reading page, wherein the book overview information at least comprises a book introduction and a book comment.

22. The method of claim 21, wherein after the displaying book contents corresponding to a reading progress of the triggered target read book and an overview information viewing control in the reading page, the method further comprises:
in response to that no trigger operation for the overview information viewing control is detected within a preset duration, hiding the overview information viewing control.

23. The method of claim 14, wherein if the book page is a historical book page, the displaying a book page in response to a target trigger operation comprises:
in response to a historical book access operation, displaying the historical book page and displaying the book attribute information of the respective historically read book in the historical book page, wherein the book attribute information comprises book identification information and additional information; the additional information comprises at least one of a reading progress, an unread duration, a book category, a book completion status, a book update status, book popularity, and key information corresponding to an unread chapter.

24. An electronic device, comprising:
a processor;
a memory, configured to store an executable instruction;
wherein the processor is configured to read the executable instruction from the memory, and perform the executable instruction to implement acts comprising:
in response to a target trigger operation, displaying a book page, wherein the book page is configured to display book attribute information of a plurality of books; and
displaying recommendation information of at least one target read book in the book page, wherein a read book is a book with unread book contents, and the recommendation information at least comprises key information of an unread chapter in the at least one target read book.

25. The device of claim 24, wherein before the displaying recommendation information of at least one target read book in the book page, the acts further comprise:
obtaining historically read books, and sorting the historically read books based on a preset sorting dimension, wherein the preset sorting dimension comprises at least one of a reading progress, an unread duration and a book category matching degree, and the book category matching degree is used to represent a matching degree between a book category to which the historically read books belong and a category of interest; and
screening the sorted historically read books based on a preset number to determine the target read book, and generating the recommendation information corresponding to the target read book based on information of the unread chapter in the target read book, wherein the preset number is an integer greater than or equal to 1.

26. The device of claim 24, wherein the displaying recommendation information of at least one target read book in the book page comprises:
displaying a banner control in a peripheral region of the book page, and displaying the recommendation information of one target read book in the banner control.

27. The device of claim 26, wherein the displaying the recommendation information of one target read book in the banner control comprises:
in response to that a number of the at least one target read book is one, displaying the recommendation information of the target read book in the banner control; and
in response to that the number of the at least one target read book is more than one, displaying the recommendation information of each of the at least one target read book in the banner control one by one.

28. The device of claim 24, wherein the displaying recommendation information of at least one target read book in the book page comprises:
in response to that a number of the at least one target read book is more than one, displaying a book entry control in the book page, and displaying prompt information for viewing the recommendation information in the book entry control; and
in response to a trigger operation for the book entry control, displaying the recommendation information of each of the at least one target read book at a first preset position of the book page.

29. The device of claim 28, wherein the displaying the recommendation information of each of the at least one target read book at a first preset position of the book page comprises:
creating a floating window in the book page, and displaying the respective recommendation information in the floating window; or
moving the respective book attribute information in the book page, and displaying the respective recommendation information in a moved blank region; or
switching from the book page to a new page, and displaying the respective recommendation information in the new page.

30. The device of claim 24, wherein the displaying recommendation information of at least one target read book in the book page comprises:
in response to a number of the target read books is more than one, determining a first region and a second region in the book page, and displaying the recommendation information of the respective target read books in the first region, and displaying the respective book attribute information in the second region.

31. The device of claim 24, wherein after the displaying recommendation information of at least one target read book in the book page, the acts further comprise:
in response to a trigger operation for the target read book, displaying a reading page, and displaying book contents corresponding to a reading progress of the triggered target read book and an overview information viewing control in the reading page; and
in response to a trigger operation for the overview information viewing control, displaying book overview information of the triggered target read book at a second preset position of the reading page, wherein the book overview information at least comprises a book introduction and a book comment.

32. The device of claim 31, wherein after the displaying book contents corresponding to a reading progress of the triggered target read book and an overview information viewing control in the reading page, the acts further comprise:
in response to that no trigger operation for the overview information viewing control is detected within a preset duration, hiding the overview information viewing control.

33. A non-transitory computer-readable storage medium, wherein the storage medium stores a computer program, and the computer program, when is executed by a processor, causes the processor to implement acts comprising:
in response to a target trigger operation, displaying a book page, wherein the book page is configured to display book attribute information of a plurality of books; and
displaying recommendation information of at least one target read book in the book page, wherein a read book is a book with unread book contents, and the recommendation information at least comprises key information of an unread chapter in the at least one target read book.
